(19) United States
(12) Patent Application Publication
(10) Pub. No.: US 2018/0275615 A1
(43) Pub. Date: Sep. 27, 2018

(54) INFORMATION DISPLAY METHOD, SYSTEM, PROGRAM, AND INFORMATION DISPLAY DEVICE

(71) Applicant: SEIKO EPSON CORPORATION, Tokyo (JP)

(72) Inventor: Seiichi TANAKA, Nagawa-machi (JP)

(73) Assignee: SEIKO EPSON CORPORATION, Tokyo (JP)

(21) Appl. No.: 15/918,475

(22) Filed: Mar. 12, 2018

(30) Foreign Application Priority Data
Mar. 23, 2017 (JP) 2017-058255

(51) Int. Cl. G04G 9/08; G04B 19/04; G06T 7/73

(52) U.S. Cl. CPC G04G 9/087; G06T 7/75; G04B 19/042

(57) ABSTRACT

An information display method includes recognizing a position relationship between a dial and an indicating hand from an image in which an electronic timepiece having a dial and an indicating hand for indicating the dial is included as an imaged subject, specifying a value corresponding to the position relationship, based on specification information of the electronic timepiece, and displaying an annotation image relating to the specified value along with the image.

### CROSS-REFERENCE TO RELATED APPLICATION

This nonprovisional application claims the benefit of Japanese Patent Application No.2017-058255 filed Mar. 23, 2017, the enter disclosure which is incorporated herein by reference.

### BACKGROUND

### 1. Technical Field

The present invention relates to an information display method, a system, a program, and an information display device.

### 2. Related Art

An electronic timepiece is known in which a physical quantity such as temperature, altitude, barometric pressure is measured so as to be displayed using an information indicating hand different from an indicating hand for indicating the time. For example, JP-A-2013-57517 discloses an electronic timepiece including physical quantity measuring unit that measures a physical quantity such as temperature, a dedicated information indicating hand that indicates a physical quantity measurement value, a scale unit that has a dedicated scale displayed thereon in order for the indicating hand to indicate the measurement value, and a display unit that displays numerical values so as to specify upper and lower ranges of the physical quantity measurement value displayed by the scale unit indicating the scale.

However, according to the electronic timepiece as disclosed in JP-A-2013-57517, the information indicating hand and the dedicated scale unit which indicate the physical quantity measurement value are smaller than the indicating hand and the scale unit which indicate the time. As a result, in some cases, it is difficult for a user to accurately view a value indicated by the information indicating hand and the scale unit.

On the other hand, in recent years, a mobile terminal device such as a smartphone and a tablet computer has been widely used, and it becomes common that the user possesses the mobile terminal device along with the electronic timepiece. Many mobile terminal devices include a camera and a display, which can be used so as to provide various information items for the user.

### SUMMARY

An advantage of some aspects of the invention is to provide a new and improved information display method, system, program, and information display device, in which an information display device such as a mobile terminal device, is combined with an electronic timepiece so as to enable a user to accurately and easily recognize information indicated by the electronic timepiece.

An information display method according to an aspect of the invention includes recognizing a position relationship between a dial and an indicating hand from an image in which an electronic timepiece having a dial and an indicating hand for indicating the dial is included as an imaged subject, specifying a value corresponding to the position relationship, based on specification information of the electronic timepiece, and displaying an annotation image relating to the specified value along with the image.

According to this configuration, a user can refer to the annotation image displayed along with the image in which the electronic timepiece is included as the imaged subject. In this manner, the user can accurately and easily recognize information relating to the value indicated by the dial and the indicating hand of the electronic timepiece. The value is specified, based on the position relationship between the dial and the indicating hand which are recognized from the image and the specification information of the electronic timepiece. Accordingly, for example, the electronic timepiece may not have a function to communicate with the information display device.

In the information display method, the dial may include a main dial, and a sub dial disposed in a partial region of the main dial. The indicating hand may include a sub indicating hand for indicating the sub dial. In the recognizing the position relationship, the position relationship between the sub dial and the sub indicating hand may be recognized.

According to this configuration, the user can accurately and easily recognize the value indicated by the sub dial and the sub indicating hand. The sub dial and the sub indicating hand are smaller than the main dial and a center hand. Accordingly, in some cases, the user is less likely to view the indicated value. Therefore, the annotation image may be advantageously displayed in recognizing the information relating to the indicated value.

In the information display method, in the specifying the value, the value may be specified, based on a sensor measurement value indicated by the electronic timepiece.

According to this configuration, the user can accurately and easily recognize the value, based on the sensor measurement value indicated by the electronic timepiece. Unlike the time, the value based on the sensor measurement value is indicated using various methods. Therefore, the information provided by the annotation image is effectively used as user auxiliary information for reading the indicated value.

In the information display method, in the displaying the annotation image, the annotation image may be displayed in association with the indicating hand for indicating the specified value.

According to this configuration, the user easily recognizes how the value is displayed by the dial and the indicating hand.

In the information display method, the indicating hand may include a first indicating hand and a second indicating hand. In the recognizing the position relationship, a first position relationship between the dial and the first indicating hand and a second position relationship between the dial and the second indicating hand may be recognized. In the specifying the value, a first value corresponding to the first position relationship and a second value corresponding to the second position relationship may be specified. In the displaying the annotation image, the annotation image relating to the first value may be displayed in association with the first indicating hand, and the annotation image relating to the second value may be displayed in association with the second indicating hand.

According to this configuration, in a case where a plurality of indicating hands individually indicate the value in the electronic timepiece, the user easily recognizes the value indicated by each of the indicating hands.

In the information display method, in the displaying the annotation image, the annotation image relating to a value whose elements are the first value and the second value may be further displayed.

According to this configuration, in a case where each of the elements is decomposed and the value is indicated by the plurality of indicating hands in the electronic timepiece, the user easily recognizes the value of the element indicated by each of the indicating hands and the value configured to include the elements.

In the information display method, the specification information may include first specification information that associates a plurality of indicating modes settable in the electronic timepiece with the position relationship, and second specification information that associates a value indicated by each of the plurality of indicating modes with the position relationship. In the specifying the value, the indicating mode corresponding to the position relationship may be specified, based on the first specification information, and the value corresponding to the position relationship may be specified, based on the second specification information and the specified indicating mode.

According to this configuration, the plurality of indicating modes can be set in the electronic timepiece. In a case where the value indicated by the dial and the indicating hand varies depending on the indicating mode, the indicating mode is specified, based on the first specification information, and the value is specified, based on the second specification information. In this manner, the user can accurately specify the value indicated by the electronic timepiece.

In the information display method, the annotation image may include the annotation image relating to the specified indicating mode.

According to this configuration, the user easily recognizes the indicating mode set by the electronic timepiece.

In the information display method, the indicating hand may include a first indicating hand and a second indicating hand. In the recognizing the position relationship, a first position relationship between the dial and the first indicating hand and a second position relationship between the dial and the second indicating hand may be recognized. In the specifying the value, the indicating mode corresponding to the first position relationship may be specified, based on the first specification information, and the value corresponding to the second position relationship may be specified, based on the second specification information and the specified indicating mode. In the displaying the annotation image, the annotation image relating to the specified indicating mode may be displayed in association with the first indicating hand.

According to this configuration, in a case where the indicating mode is indicated using the first indicating hand and the value is indicated using the second indicating hand in the electronic timepiece, the user can easily recognize whether each of the indicating hands indicates the indicating mode or indicates the value.

In the information display method, in the recognizing the position relationship, models of the electronic timepiece maybe recognized from the image. In the specifying the value, the value corresponding to the position relationship may be recognized, based on the specification information prepared for each of the models.

According to this configuration, for example, in a case where the specification information varies depending on each model, the user can accurately specify the indicated value.

A system according to an aspect of the invention includes an electronic timepiece that includes a dial, an indicating hand for indicating the dial, and an indicating hand drive control unit which controls driving of the indicating hand so as to indicate a value by using a position relationship with the dial, and an information display device that includes an imaging unit which acquires an image in which the electronic timepiece is included as an imaged subject, an image recognition unit which recognizes the position relationship between the dial and the indicating hand from the image, an analysis unit which specifies the value, based on specification information of the electronic timepiece and the position relationship, and a display control unit which displays an annotation image relating to the specified value along with the image.

A program according to an aspect of the invention causes a processor of a computer to function as an image recognition unit that recognizes a position relationship between a dial and an indicating hand from an image in which an electronic timepiece having the dial and the indicating hand for indicating the dial are included as an imaged subject, an analysis unit that specifies a value corresponding to the position relationship, based on specification information of the electronic timepiece, and a display control unit that displays an annotation image relating to the specified value along with the image.

An information display device according to an aspect of the invention includes an image recognition unit that recognizes a position relationship between a dial and an indicating hand from an image in which an electronic timepiece having the dial and the indicating hand for indicating the dial are included as an imaged subject, an analysis unit that specifies a value corresponding to the position relationship, based on specification information of the electronic timepiece, and a display control unit that displays an annotation image relating to the specified value along with the image.

### BRIEF DESCRIPTION OF THE DRAWINGS

The invention will be described with reference to the accompanying drawings, wherein like numbers reference like elements.

FIG. 1 is a front view of an electronic timepiece according to an embodiment of the invention.

FIG. 2 is a schematic block diagram illustrating a circuit configuration of the electronic timepiece illustrated in FIG. 1.

FIG. 3 is a flowchart illustrating a process example in the electronic timepiece according to the embodiment of the invention.

FIG. 4 illustrates a configuration of a system including the electronic timepiece according to the embodiment of the invention.

FIG. 5 is a schematic block diagram illustrating a configuration of a smartphone according to the embodiment of the invention.

FIG. 6 is a flowchart illustrating an example of an information display method according to the embodiment of the invention.

FIG. 7 illustrates a first screen display example according to the embodiment of the invention.

FIG. 8 illustrates a second screen display example according to the embodiment of the invention.

FIG. 9 illustrates a third screen display example according to the embodiment of the invention.

FIG. 10 illustrates a fourth screen display example according to the embodiment of the invention.

FIG. 11 illustrates a fifth screen display example according to the embodiment of the invention.

FIG. 12 illustrates a sixth screen display example according to the embodiment of the invention.

FIG. 13 illustrates a seventh screen display example according to the embodiment of the invention.

FIG. 14 illustrates an eighth screen display example according to the embodiment of the invention.

### DESCRIPTION OF EXEMPLARY EMBODIMENTS

Hereinafter, a preferred embodiment according to the invention will be described in detail with reference to the accompanying drawings. In the description herein and the drawings, the same reference numerals will be given to configuration elements having substantially the same functional configuration, and repeated description will be omitted.

### Configuration of Electronic Timepiece

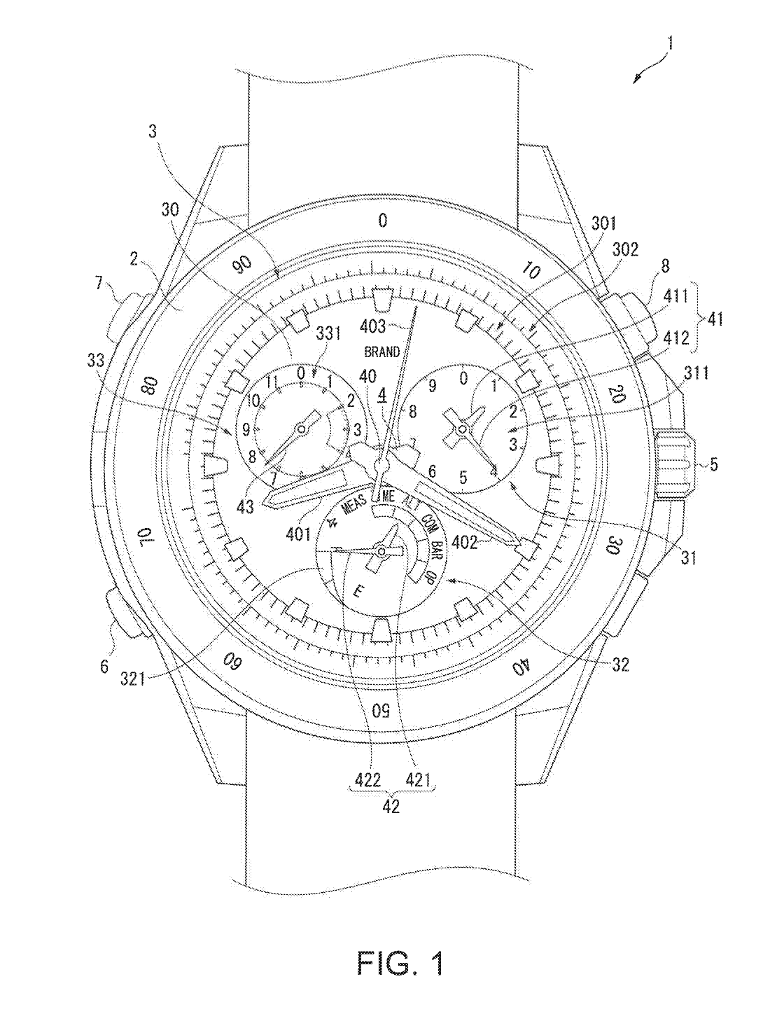

FIG. 1 is a front view of an electronic timepiece according to the embodiment of the invention. Referring to FIG. 1, an electronic timepiece 1 is a wrist watch worn on a wrist of a user. The electronic timepiece 1 includes an exterior case 2, a disk-shaped dial 3, an indicating hand 4 that indicates the dial 3, and a crown 5, an A-button 6, a B-button 7, and a C-button 8 which are operation members. The dial 3 includes a main dial 30, and a first sub dial 31, a second sub dial 32, and a third sub dial 33 which are arranged in a partial region of the main dial 30. The indicating hand 4 includes a center hand 40 (hour hand 401, minute hand 402, and chronograph second hand 403) that indicates the main dial 30, a first sub indicating hand 41 (short hand 411 and long hand 412) that indicates the first sub dial 31, a second sub indicating hand 42 (short hand 421 and long hand 422) that indicates the second sub dial 32, and a small second hand 43 that indicates the third sub dial 33. Each hand included in the indicating hand 4 is driven by a motor disposed inside a movement (not illustrated) of the electronic timepiece 1.

The main dial 30 includes a first scale 301 (60 divisions) disposed on an outer periphery and a second scale 302 (100 divisions). The first scale 301 is used when an hour hand 401 and a minute hand 402 indicate the time, and is additionally used when indicating a sensor measurement value. The second scale 302 is used when indicating the sensor measurement value. The first sub dial 31 is disposed in a direction of 2 o' clock when viewed from a plane center of the main dial 30. The first sub dial 31 includes a scale 311 (10 divisions) disposed on the outer periphery. The second sub dial 32 is disposed in a direction of 6 o' clock direction when viewed from the plane center of the main dial 30. The second sub dial 32 includes a portion where characters such as “MEAS”, “TIME”, “ALT”, “BAR”, and “OP”” are marked on the outer periphery, and a portion having a scale 321 marked thereon for indicating battery remaining capacity. The third sub dial 33 is disposed in a direction of 10 o' clock when viewed from the plane center of the main dial 30. The third sub dial 33 includes a scale 331 (12 divisions) disposed on the outer periphery.

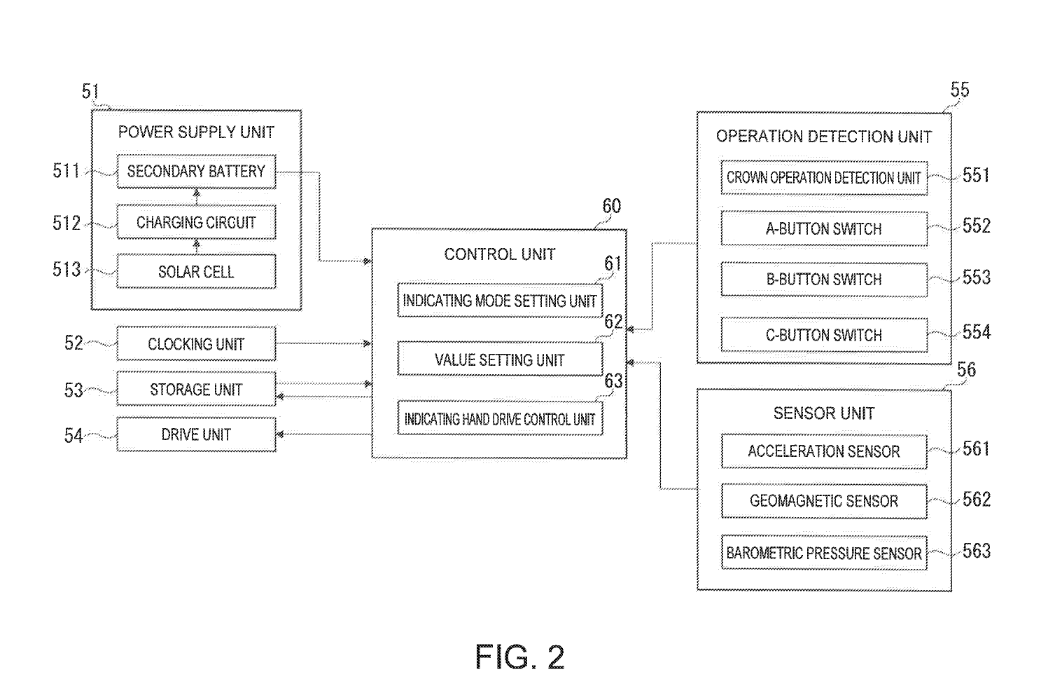

FIG. 2 is a schematic block diagram illustrating a circuit configuration of the electronic timepiece illustrated in FIG. 1. Referring to FIG. 2, the electronic timepiece 1 includes a power supply unit 51, a clocking unit 52, a storage unit 53, a drive unit 54, an operation detection unit 55, a sensor unit 56, and a control unit 60.

The power supply unit 51 includes a secondary battery 511 configured to include a lithium-ion battery, a charging circuit 512, and a solar cell 513. The secondary battery 511 is charged with electric power generated by the solar cell 513 via the charging circuit 512, and supplies the electric power to each unit of the electronic timepiece 1. A voltage detection circuit (not illustrated) connected to the secondary battery 511 outputs a signal indicating the remaining battery capacity to the control unit 60.

The clocking unit 52 updates time data using a reference signal generated through frequency-dividing of an oscillation signal of a crystal oscillator. The clocking unit 52 outputs the time data to the control unit 60. The clocking unit 52 and the storage unit 53 may be integrally installed in a microcontroller configuring the control unit 60.

The storage unit 53 is configured to include a random access memory (RAM) and a read only memory (ROM), and stores a program executed by the control unit 60 and data used for executing the program. The storage unit 53 may store a measurement value of various sensors included in the sensor unit 56 (to be described later) in association with the time.

The drive unit 54 includes a drive mechanism for respectively and rotationally driving the center hand 40, the first sub indicating hand 41, the second sub indicating hand 42, and the small second hand 43 which configure the indicating hand 4. The drive mechanism is configured to include a stepping motor and a train wheel, and rotationally drives each of the indicating hands by driving the stepping motor in response to a drive pulse input from the control unit 60.

The operation detection unit 55 includes a crown operation detection unit 551, an A-button switch 552, a B-button switch 553, and a C-button switch 554. The crown operation detection unit 551 detects the number of pullout stages and a rotation amount of the crown 5. The A-button switch 552, the B-button switch 553, and the C-button switch 554 detect that the A-button 6, the B-button 7, and the C-button 8 are pressed or released by a user. Each detection unit outputs a detection signal to the control unit 60.

The sensor unit 56 includes an acceleration sensor 561, a geomagnetic sensor 562, and a barometric pressure sensor 563. In addition to these sensors, the sensor unit 56 may also include sensors providing various measurement values, including those not included in a specific example (to be described later), such as a temperature sensor or a UV sensor. The sensor unit 56 outputs a measurement value of various sensors to the control unit 60. The sensor measurement value may be used on a real time basis in the control unit 60, or may be stored in the storage unit 53 in association with the time.

In another example, the electronic timepiece 1 may include a communication unit for receiving the measurement value of a sensor included in a sensor device separate from the electronic timepiece 1. For example, the communication unit communicates with the sensor device by using the Bluetooth (registered trademark). The measurement value received from the sensor device on a real time basis by the communication unit, or the measurement value stored in association with the time in the sensor device is used similarly to the sensor measurement value output by the sensor unit 56 as described above.

The control unit 60 is configured to include a microcontroller, and controls each unit of the electronic timepiece 1 by executing a program stored in the storage unit 53. For example, the control unit 60 sets an indicating mode of the electronic timepiece 1 in accordance with an operation of a user which is detected by the operation detection unit 55. In accordance with the set indicating mode and the sensor measurement value corresponding to the indicating mode, the control unit 60 controls the drive unit 54 to drive the indicating hand 4. In the embodiment, the control unit 60 functions as an indicating mode setting unit 61, a value setting unit 62, and an indicating hand drive control unit 63 (to be described below).

For example, the indicating mode setting unit 61 sets the indicating mode of the electronic timepiece 1, based on a detection signal output from the operation detection unit 55 when the A-button 6, the B-button 7, or the C-button 8 is pressed and released by the user. In the embodiment, the indicating mode setting unit 61 can set a time mode, a chronograph mode, an altitude mode, an azimuth mode, a barometric pressure mode, and a pedometer mode in the electronic timepiece 1. Details of each display mode will be described later.

The value setting unit 62 sets a value which the electronic timepiece 1 indicates by using a position relationship between the dial 3 and the indicating hand 4. The value setting unit 62 sets the value in accordance with the indicating mode set by the indicating mode setting unit 61. Specifically, as the respectively indicated values, the value setting unit 62 sets a time measurement value in the chronograph mode, sets an altitude based on the measurement value of the barometric pressure sensor 563 in the altitude mode, sets an azimuth angle based on the measurement value of the geomagnetic sensor 562 in the azimuth mode, sets barometric pressure based on the measurement value of the barometric pressure sensor 563 in the barometric pressure mode, and sets the number of walking steps counted based on the measurement value of the acceleration sensor 561 in the pedometer mode. The value setting unit 62 may set a common value regardless of the indicating mode. Specifically, as the indicated value, the value setting unit 62 may set the battery remaining capacity based on a signal output from the secondary battery 511 in one or more display modes described above.

The indicating hand drive control unit 63 controls the drive unit 54 to drive the indicating hand 4 so that the indicating hand 4 indicates the value set by the value setting unit 62. The indicating hand drive control unit 63 controls the drive unit 54 to drive the indicating hand 4 so that the indicating hand 4 indicates the indicating mode set by the indicating mode setting unit 61. Specifically, the indicating hand drive control unit 63 outputs a drive pulse to the drive unit 54 so that the indicating hand 4 (the chronograph second hand 403, the first sub indicating hand 41, and the second sub indicating hand 42 of the center hand 40) indicates the value or the indicating mode by using a position relationship with the dial 3 (the main dial 30, the first sub dial 31, and the second sub dial 32).

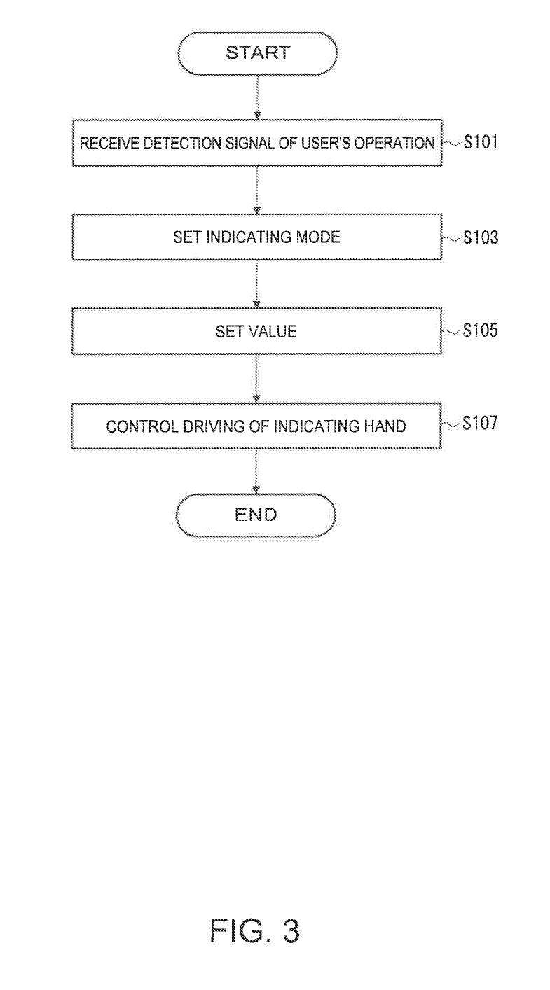

FIG. 3 is a flowchart illustrating a process example in the electronic timepiece according to the embodiment of the invention. The illustrated process is performed by the control unit 60 (the indicating mode setting unit 61, the value setting unit 62, and the indicating hand drive control unit 63) of the electronic timepiece 1.

First, the indicating mode setting unit 61 receives a detection signal of a user's operation from the operation detection unit 55 (Step S101). Here, the received detection signal is output when any one of the A-button 6, the B-button 7, and the C-button 8 is pressed and released.

Next, the indicating mode setting unit 61 sets the indicating mode of the electronic timepiece 1 in accordance with the received detection signal (Step S103). Here, the indicating mode to be set is selected from the settable indicating modes in accordance with the detection signal received in Step S101 and the indicating mode previously set at the time of Step S101. In the embodiment, the user can sequentially switch the time mode, the altitude mode, the azimuth mode, the barometric pressure mode, and the pedometer mode by repeatedly pressing and releasing the A-button 6. The user presses the C-button 8, thereby setting the chronograph mode.

Next, in accordance with the indicating mode set in Step S103, the value setting unit 62 sets the value which the electronic timepiece 1 indicates by using the position relationship between the dial 3 and the indicating hand 4 (Step S105). As described above, for example, the setting value is set, based on the measurement value of the sensor included in the sensor unit 56. The value setting unit 62 may set the value such as the battery remaining capacity, regardless of the indicating mode.

Next, the indicating hand drive control unit 63 outputs a control pulse to the drive unit 54 so as to indicate the value set in Step S105, thereby controlling the driving of the indicating hand 4 (Step S107). At this time, the indicating hand drive control unit 63 outputs the control pulse to the drive unit 54 so as to indicate the indicating mode set in Step S103, when indicating the value or before indicating the value, thereby controlling the driving of the indicating hand 4.

Through the above-described process, in the electronic timepiece 1 including the dial 3 and the indicating hand 4 for indicating the dial 3, the driving of the indicating hand 4 is controlled so that the value such as the sensor measurement value or the indicating mode is indicated by using the position relationship with the dial 3.

Configuration of System Including Electronic Timepiece

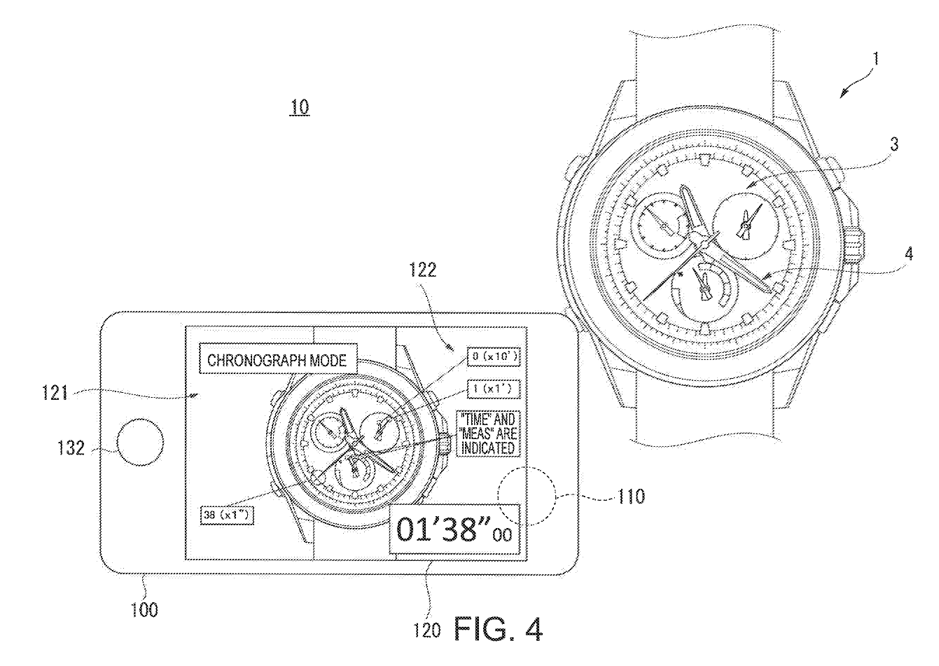

FIG. 4 illustrates a configuration of a system including the electronic timepiece according to the embodiment of the invention. A system 10 includes the electronic timepiece 1 and a smartphone 100. In the illustrated state, a camera 110 of the smartphone 100 is activated, and the camera 110 acquires an image in which the electronic timepiece 1 is included as an imaged subject. At this time, a display 120 serving as a display unit displays an annotation image 122 along with an image 121 including the electronic timepiece 1, which is a so-called live view image.

In the embodiment, the annotation image 122 relates to the value indicated by using the position relationship between the dial 3 and the indicating hand 4 in the electronic timepiece 1. Specifically, the annotation image 122 includes an annotation image illustrating the value itself. The value may be based on the sensor measurement value acquired by the sensor included in the sensor unit 56 in the electronic timepiece 1. The annotation image 122 may include an annotation image relating to the indicating mode associated with the indicated value.

Since the annotation image 122 is displayed, for example, even in a case where the user is less likely to accurately view the dial 3 and the indicating hand 4 of the electronic timepiece 1, the user can accurately and easily recognize information indicated in the electronic timepiece 1. For example, the respective values indicated by the first sub dial 31, the second sub dial 32, and the third sub dial 33, the first sub indicating hand 41, the second sub indicating hand 42, and the small second hand 43 are less likely to be visible in some cases, since the sub dial and the sub indicating hand are smaller than the main dial 30 and the center hand 40. Therefore, the annotation image 122 can be advantageously displayed for recognizing information relating to the indicated value.

In the respective drawings subsequent to FIG. 4, the characters marked on the dial 3 of the electronic timepiece 1 are omitted in the illustration, since the characters are too small. References to the characters in the following description are understood with reference to FIG. 1 which illustrates the characters marked on the dial 3 and the respective drawings.

### Configuration of Smartphone

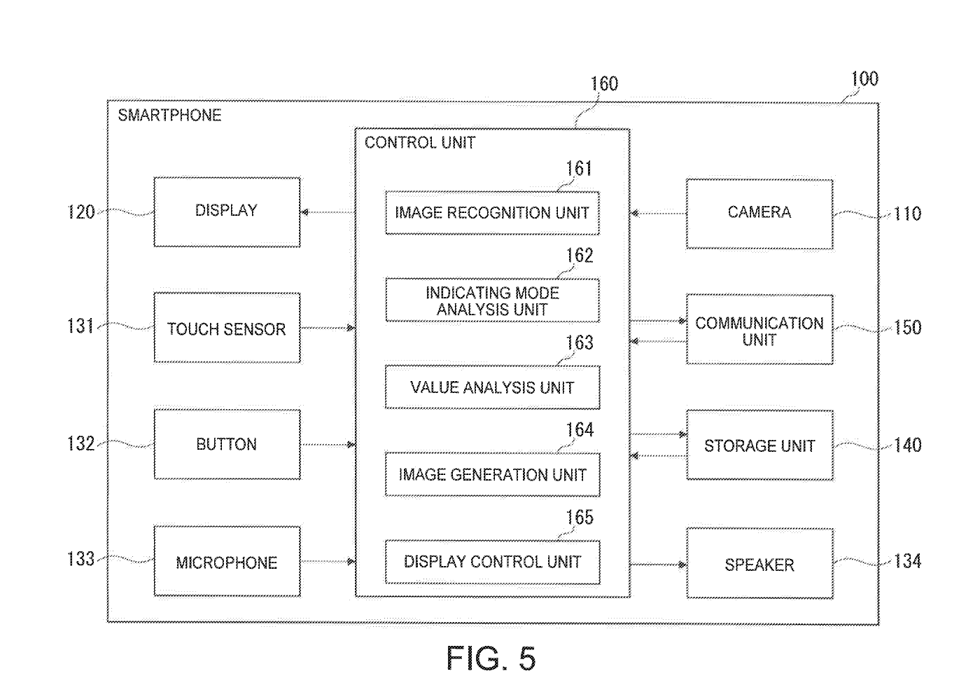

FIG. 5 is a schematic block diagram illustrating a configuration of the smartphone according to the embodiment of the invention. Referring to FIG. 5, the smartphone 100 includes the camera 110, a display 120, a touch sensor 131, a button 132, a microphone 133, a speaker 134, a storage unit 140, a communication unit 150, and a control unit 160.

The camera 110 includes a lens, an image sensor, and an image processing circuit, and converts an optical image incident on the lens into digital image data, thereby outputting the digital image data. The camera 110 continuously outputs the image data at a predetermined frame rate when activated. The image data output in this way is continuously displayed on the display 120, thereby providing a so-called live view image. In the embodiment, the camera 110 serves as an imaging unit that acquires the image in which the electronic timepiece 1 is included as the imaged subject.

For example, the display 120 is a liquid crystal display (LCD) or an organic electro luminescence (EL) display, and displays various information items as the image in accordance with the image data input from the control unit 160. The touch sensor 131 is disposed on the display 120, and a touch screen is configured to include the display 120 and the touch sensor 131. In the embodiment, the display 120 serves as a display unit that displays the annotation image 122 along with the live view image in which the electronic timepiece 1 is included as the imaged subject, which is acquired by the camera 110.

The touch sensor 131 and the button 132 generate an operation signal in accordance with an operation of the user. The generated operation signal is input to the control unit 160. Instead of or in addition to the operation signal, a voice signal generated by the microphone 133 may be input to the control unit 160 as information indicating the operation input of the user. The speaker 134 outputs various information items as a voice in accordance with the voice signal output from the control unit 160.

The storage unit 140 is configured to include the RAM and the ROM. The storage unit 140 stores a program executed by the control unit 160 and data used for executing the program. In the embodiment, the storage unit 140 stores an image dictionary for recognizing the electronic timepiece 1, and the dial 3 and the indicating hand 4 of the electronic timepiece 1. The storage unit 140 stores specification information of the electronic timepiece 1 for specifying the value indicated by the dial 3 and the indicating hand 4 in the electronic timepiece 1, based on the position relationship between the dial 3 and the indicating hand 4 in the image.

The communication unit 150 includes a device such as a communication circuit and an antenna for communication between the smartphone 100 and other devices. For example, the communication unit 150 performs the communication using a network such as a mobile communication network or a wireless local area network (LAN), and connects the smartphone 100 to a network such as the Internet. The communication unit 150 may perform inter-device communication with other devices by using the Bluetooth (registered trademark).

The control unit 160 is configured to include a processor such as a central processing unit (CPU). The control unit 160 controls each unit of the smartphone 100 by executing the program stored in the storage unit 140. In a case where the program according to the embodiment is executed, the control unit 160 functions as an image recognition unit 161, an indicating mode analysis unit 162, a value analysis unit 163, an image generation unit 164, and a display control unit 165 (to be described below).

The image recognition unit 161 performs an image recognition process for the image 121 acquired by the camera 110. The image recognition unit 161 recognizes the electronic timepiece 1 included as the imaged subject in the image 121, and further recognizes the position relationship between the dial 3 and the indicating hand 4 of the electronic timepiece 1. At this time, the image recognition unit 161 recognizes the position relationship by using the image dictionary of the electronic timepiece 1, the dial 3, the indicating hand 4, which is stored in the storage unit 140. For example, the image dictionary may include a first image dictionary including the image of the electronic timepiece 1 of various models and a second image dictionary prepared for each model of the electronic timepiece 1. In this case, the image recognition unit 161 recognizes the model of the electronic timepiece 1 from the image by using the first image dictionary, and recognizes the position relationship between the dial 3 and the indicating hand 4 of the electronic timepiece 1 from the image by using the second image dictionary corresponding to the recognized model. In another example, the second image dictionary corresponding to the model of the electronic timepiece 1 which is selected in advance by the user may be used. In this case, the first image dictionary does not need to be prepared.

Based on the specification information of the electronic timepiece 1 which is stored in the storage unit 140, the indicating mode analysis unit 162 specifies the indicating mode corresponding to the position relationship between the dial 3 and the indicating hand 4 of the electronic timepiece 1, which is recognized by the image recognition unit 161. Here, the specification information of the electronic timepiece 1 includes first specification information in which a plurality of indicating modes settable in the electronic timepiece 1 are associated with the position relationship between the dial 3 and the indicating hand 4. In the embodiment, the indicating modes settable in the electronic timepiece 1 includes the time mode, the chronograph mode, the altitude mode, the azimuth mode, the barometric pressure mode, and the pedometer mode. For example, the position relationship between the dial 3 and the indicating hand 4 which is associated with the indicating mode in the first specification information is the position relationship between a portion having the characters marked on the second sub dial 32, and the short hand 421 and the long hand 422.

Based on the indicating mode of the electronic timepiece 1 which is specified by the indicating mode analysis unit 162 and the specification information of the electronic timepiece 1 which is stored in the storage unit 140, the value analysis unit 163 specify the value corresponding to the position relationship between the dial 3 and the indicating hand 4 of the electronic timepiece 1 which is recognized by the image recognition unit 161. Here, the specification information of the electronic timepiece 1 includes second specification information in which the value indicated in each of the plurality of indicating modes settable in the electronic timepiece 1 is associated with the position relationship between the dial 3 and the indicating hand 4. In the embodiment, the indicating mode settable in the electronic timepiece 1 includes the time mode, the chronograph mode, the altitude mode, the azimuth mode, the barometric pressure mode, and the pedometer mode. The value indicated in the above-described indicating mode includes the time, the time measurement value, the altitude, the azimuth angle, the barometric pressure, and the number of walking steps. For example, the position relationship between the dial 3 and the indicating hand 4 which is associated with the value in the second specification information is the position relationship between the scale 311 on the first sub dial 31, and the short hand 411 and the long hand 412. In the second specification information, as illustrated by an example (to be described later), the value (battery remaining capacity) indicated in the electronic timepiece 1 regardless of the indicating mode may be associated with the position relationship between the dial 3 and the indicating hand 4.

Here, the specification information of the electronic timepiece 1 which is used by the indicating mode analysis unit 162 and the value analysis unit 163 may be prepared for each model of the electronic timepiece 1. In this case, the indicating mode analysis unit 162 and the value analysis unit 163 read the specification information corresponding to the model of the electronic timepiece 1 which is recognized by the image recognition unit 161 from the image, from the storage unit 140. Alternatively, the specification information may be prepared in common for a plurality of models of the electronic timepiece 1.

The image generation unit 164 generates the annotation image 122 relating to the value specified by the value analysis unit 163. As described above, the annotation image 122 may include the annotation image indicating the value itself, and may include the annotation image relating to the indicating mode associated with the value. Specifically, the image generation unit 164 may generate the annotation image 122 indicating the value specified by the value analysis unit 163, and may generate the annotation image 122 specified by the indicating mode analysis unit 162.

The display control unit 165 causes the display 120 to display the annotation image 122 generated by the image generation unit 164 along with the image 121 in which the electronic timepiece 1 is included as the imaged subject. Here, the annotation image 122 may be displayed in association with at least either the dial 3 or the indicating hand 4 of the electronic timepiece 1 which is included in the image 121. In this case, the annotation image 122 may be displayed while being transparently superimposed on the image 121. For example, in a case where the position of the electronic timepiece 1 is changed inside the image 121 due to the movement of the user, the display control unit 165 may use the recognition result of the dial 3 and the indicating hand 4 which is obtained by the image recognition unit 161 so that the annotation image 122 is moved to follow the movement of the electronic timepiece 1 inside the image 121. A specific display example of the annotation image 122 by using the display control unit 165 will be described later.

### Example of Process Flow

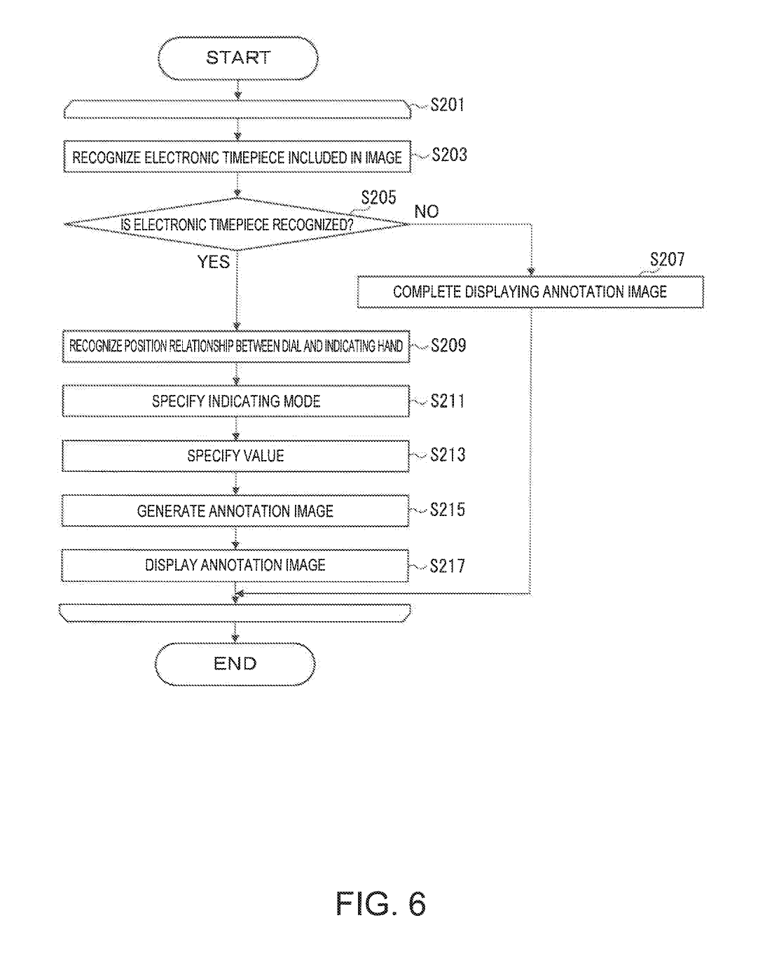

FIG. 6 is a flowchart illustrating an example of an information display method according to the embodiment of the invention. In executing the program according to the embodiment, the illustrated process is repeatedly performed at a predetermined interval by the control unit 160 (the image recognition unit 161, the indicating mode analysis unit 162, the value analysis unit 163, the image generation unit 164, and the display control unit 165) of the smartphone 100 (Step S201).

In each process, first, the image recognition unit 161 recognizes the electronic timepiece 1 included in the image 121 acquired by the camera 110 (Step S203). At this time, the image recognition unit 161 recognizes the electronic timepiece 1 by using the first image dictionary stored in the storage unit 140. The first image dictionary is prepared for a predetermined model of the electronic timepiece 1 where the indicating mode analysis unit 162 can specify the indicating mode and the value analysis unit 163 can specify the value. Therefore, in addition to a case where the timepiece is not included in the image 121, even in a case where the timepiece included in the image 121 is not the above-described predetermined model, the electronic timepiece 1 is not recognized in Step S203.

Here, in a case where the electronic timepiece 1 is not recognized in Step S203 (NO in Step S205), the display control unit 165 completes the display of the annotation image 122 in the display 120 (in a case where there is a display) (Step S207), and the process at this time is completed. On the other hand, in a case where the electronic timepiece 1 is recognized in Step S203 (YES in Step S205), the process proceeds to Step S209.

Next, the image recognition unit 161 recognizes the position relationship between the dial 3 and the indicating hand 4 of the electronic timepiece 1 which is recognized in Step S203 (Step S209). At this time, the image recognition unit 161 recognizes the position relationship by using the second image dictionary stored in the storage unit 140. The second image dictionary is prepared for each model of the electronic timepiece 1 in which the first image dictionary used in Step S203 is prepared. The second image dictionary and the model of the electronic timepiece 1 are not necessarily prepared one to one, and the second image dictionary common to a plurality of models of the electronic timepiece 1 may be prepared.

Here, in Step S209, the second image dictionary selected using the recognition result in Step S203 is used. Accordingly, it is possible to more accurately recognize the dial 3 and the indicating hand 4 of the electronic timepiece 1. For example, even in a case where a plurality of hands included in the indicating hand 4 overlap each other, it is possible to recognize an individual hand as long as any one of the tip, the middle portion, and the root of each hand appears. In a case where the hand is hidden (for example, in a case where the short hand 411 or the long hand 412 on the first sub dial 31 is hidden behind the hour hand 401 or the minute hand 402 on the main dial 30), it is possible to specify that the hand is located in a hidden region.

Next, based on the first specification information of the electronic timepiece 1 which is stored in the storage unit 140, the indicating mode analysis unit 162 specifies the indicating mode corresponding to the position relationship between the dial 3 and the indicating hand 4 which is recognized in Step S209 (Step S211). Here, the specified indicating mode is the indicating mode set in the electronic timepiece 1 included as the imaged subject in the image 121.

Next, based on the indicating mode of the electronic timepiece 1 which is specified in Step S211 and the second specification information of the electronic timepiece 1 which is stored in the storage unit 140, the value analysis unit 163 specifies the value corresponding to the position relationship between the dial 3 and the indicating hand 4 which is recognized in Step S209 (Step S213). Here, the specified value is the sensor measurement value such as the time, the measurement value of time, the altitude, the azimuth angle, the barometric pressure, or the number of walking steps indicated by the dial 3 and the indicating hand 4 in the electronic timepiece 1.

Next, the image generation unit 164 generates the annotation image 122 relating to the value specified in Step S213 (Step S215). For example, in a case where the electronic timepiece 1 is newly recognized in Step S203, the image generation unit 164 newly generates the annotation image 122 corresponding to the indicating mode and the value which are specified in Steps S211 and S213. In a case where the electronic timepiece 1 previously recognized in the previous process is continuously recognized in Step S203, if the position relationship between the dial 3 and the indicating hand 4 which is recognized in Step S209 is different from that in the previous process, the image generation unit 164 updates the annotation image 122 in accordance with the indicating mode and the value which are specified in Steps S211 and S213.

Next, the display control unit 165 causes the display 120 to display the annotation image 122 generated by the image generation unit 164 along with the image 121 where the electronic timepiece 1 is included as the imaged subject (Step S217). Specifically, the display control unit 165 outputs the image data in which the annotation image 122 is transparently superimposed on the image 121 (may be an image having a frame different from that of the image 121 used in the image recognition process in Step S203) acquired by the camera 110, to the display 120. At this time, the display control unit 165 may display the annotation image 122 in association with the indicating hand 4 for indicating the value specified in Step S213.

As described above, while the program according to the embodiment is executed, the above-described processes are repeatedly performed at a predetermined interval by the control unit 160. Therefore, the annotation image 122 newly displayed in Step S217 above is updated in Step S217 performed next time or continuously displayed. Alternatively, in a case where the electronic timepiece 1 is not recognized in Step S203, Step S207 is performed, and the display of the annotation image 122 is completed.

### Display Example

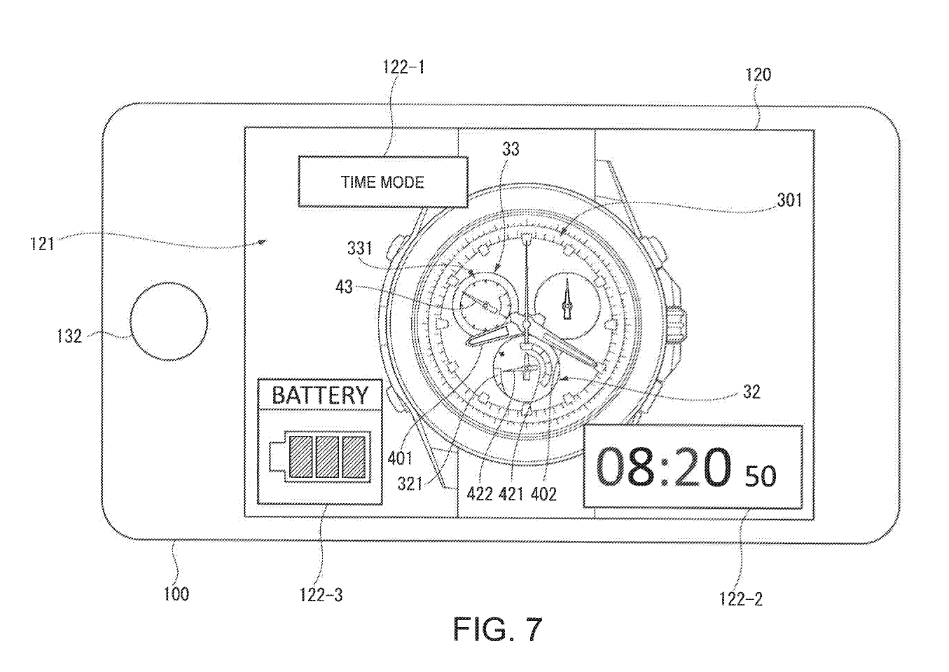

FIG. 7 illustrates a first screen display example according to the embodiment of the invention. In the illustrated example, the time mode is set in the electronic timepiece 1. In the electronic timepiece 1, while the time mode is set, the short hand 421 on the second sub dial 32 indicates a portion having the character of “TIME” marked thereon, and the long hand 422 indicates a portion having the scale 321 marked thereon for indicating the battery remaining capacity. The indicating mode analysis unit 162 of the smartphone 100 specifies the time mode set in the electronic timepiece 1 in a case where the position relationship between the second sub dial 32, and the short hand 421 and the long hand 422 which is recognized in the image 121 satisfies the above-described condition.

In the illustrated example, the image generation unit 164 generates an annotation image 122-1 for indicating the time mode specified by the indicating mode analysis unit 162, and the display control unit 165 causes the display 120 to display the annotation image 122-1 along with the image 121. Here, regardless of the indicating hand 4 (the short hand 421 and the long hand 422 on the second sub dial 32) for indicating the time mode, the annotation image 122-1 is disposed in an upper left region of the display 120.

In the illustrated example, the value analysis unit 163 specifies the time from the position relationship between the first scale 301, and the hour hand 401 and the minute hand 402 of the main dial 30, and the position relationship between the scale 331 and the small second hand 43 of the third sub dial 33. The image generation unit 164 generates an annotation image 122-2 indicating the specified time, and the display control unit 165 causes the display 120 to display the annotation image 122-2 along with the image 121. Regardless of the indicating hand 4 (the hour hand 401, the minute hand 402, and the small secondhand 43), similarly to the annotation image 122-1, the annotation image 122-2 is disposed in a lower right region of the display 120.

Furthermore, in the illustrated example, the value analysis unit 163 specifies the battery remaining capacity from the position relationship between the scale 321 indicating the battery remaining capacity of the second sub dial 32, and the long hand 422. The image generation unit 164 generates an annotation image 122-3 indicating the specified remaining battery remaining capacity, and the display control unit 165 causes the display 120 to display the annotation image 122-3 along with the image 121. Regardless of the indicating hand 4 (the long hand 422 on the second sub dial 32) indicating the battery remaining capacity, similarly to the annotation images 122-1 and 122-2, the annotation image 122-3 is disposed in a lower left region of the display 120.

In the first screen display example as described above, the annotation image 122-1 is displayed. In this manner, the user can easily recognize that the time is indicated in the electronic timepiece 1 instead of the sensor measurement value. The annotation image 122-2 displayed in the above-described example shows the time indicated by the hour hand 401 and the minute hand 402 on the main dial 30 which are relatively visible. However, the hour hand 401 and the minute hand 402 are not necessarily visible depending on the position relationship among the eyes of the user, the smartphone 100, and the electronic timepiece 1, the brightness of the surrounding environment, or the eyesight of the user. Accordingly, the annotation image 122-2 may be advantageously displayed in some cases. Since the annotation image 122-3 is displayed, the user can accurately and easily recognize the battery remaining capacity indicated by the long hand 422 on the second sub dial 32 which is smaller than the center hand 40.

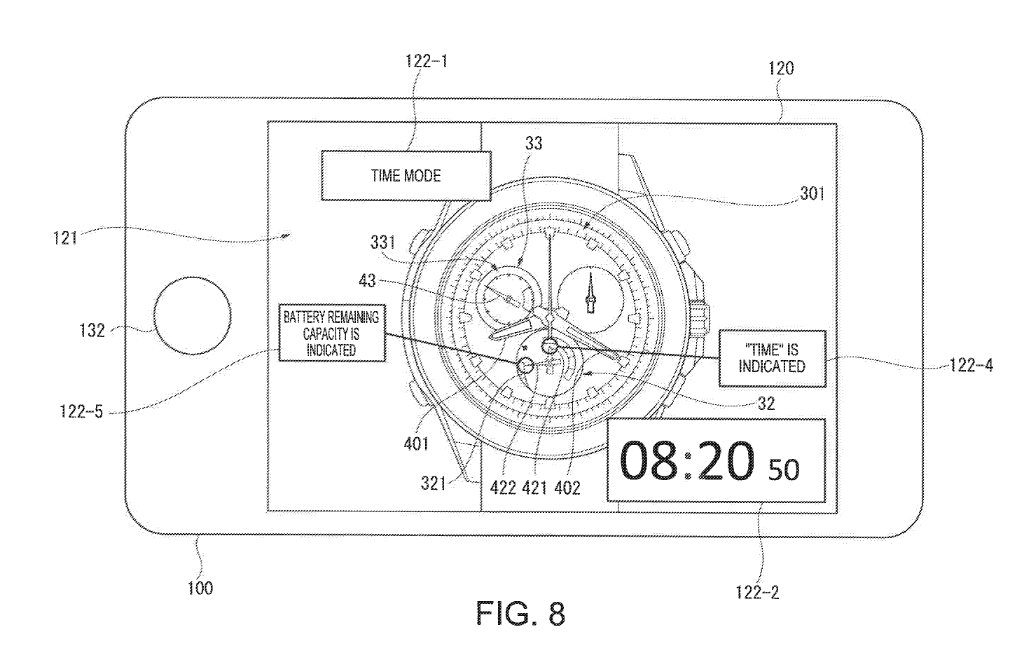

FIG. 8 illustrates a second screen display example according to the embodiment of the invention. The illustrated example is a screen display example different from that in FIG. 7 in a case where the time mode is set in the electronic timepiece 1. In the example illustrated in FIG. 8, similarly to the example in FIG. 7, the indicating mode analysis unit 162 of the smartphone 100 specifies the time mode set in the electronic timepiece 1, and the display control unit 165 causes the display 120 to display the annotation images 122-1 and 122-2 along with the image 121.

In the illustrated example, the image generation unit 164 generates other annotation images 122-4 and 122-5 relating to the mode (time mode) specified by the indicating mode analysis unit 162. The annotation image 122-4 indicates that the short hand 421 on the second sub dial 32 indicates a portion having the character of “TIME” marked thereon in the time mode, and is displayed in association with the short hand 421 included in the image 121 as the imaged subject. The annotation image 122-5 indicates that the long hand 422 on the second sub dial 32 indicates a portion having the scale 321 marked thereon for indicating the battery remaining capacity in the time mode, and is displayed in association with the long hand 422 included in the image 121 as the imaged subject.

In the above-described example, in the smartphone 100, the image recognition unit 161 recognizes a first position relationship between the dial and the first indicating hand, and a second position relationship between the dial and the second indicating hand. Specifically, the first position relationship means the position relationship between the second sub dial 32, and the short hand 421 and the long hand 422. The second position relationship means the position relationship between the main dial 30, and the hour hand 401 and the minute hand 402, and the position relationship between the third sub dial 33 and the small second hand 43. In this case, the indicating mode analysis unit 162 specifies the indicating mode (time mode) corresponding to the above-described first position relationship, and the value analysis unit 163 specifies the value (time) corresponding to the second position relationship. The display control unit 165 causes the display 120 to display the annotation images 122-4 and 122-5 relating to the specified indicating mode (time mode) in association with the first indicating hand (the short hand 421 and the long hand 422 on the second sub dial 32).

In the second screen display example as described above, the annotation images 122-4 and 122-5 are displayed in association with the indicating hand (the short hand 421 and the long hand 422 on the second sub dial 32) indicating the time mode in the electronic timepiece 1. Accordingly, the user easily recognizes that the indicating hand indicates the time mode. In this manner, for example, even in a case where the user directly views the electronic timepiece 1 without using the smartphone 100, the user can easily recognize that the time mode is set.

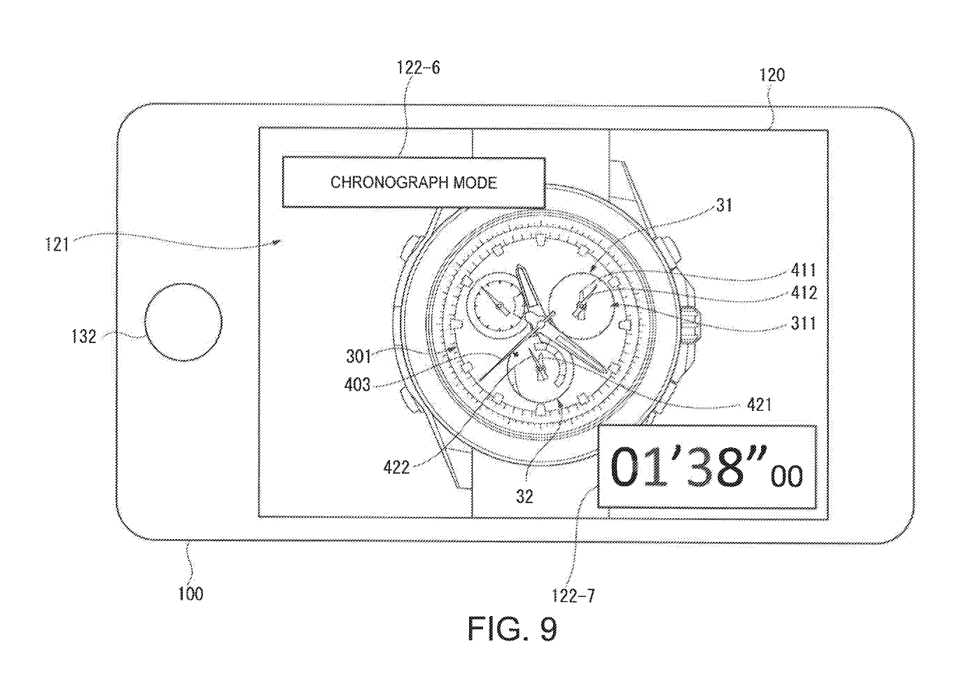

FIG. 9 illustrates a third screen display example according to the embodiment of the invention. In the illustrated example, the chronograph mode is set in the electronic timepiece 1. In the electronic timepiece 1, the chronograph mode is set, for example, in a case where the C-button 8 is pressed while the time mode is set. In the electronic timepiece 1, while the chronograph mode is set, the short hand 421 on the second sub dial 32 indicates a portion having the character of “TIME” marked thereon, and the long hand 422 indicates a portion having the character of “MEAS” marked thereon. The indicating mode analysis unit 162 of the smartphone 100 specifies the chronograph mode set in the electronic timepiece 1 in a case where the above-described condition is satisfied.

In the illustrated example, the image generation unit 164 generates an annotation image 122-6 indicating the indicating mode (chronograph mode) specified by the indicating mode analysis unit 162, and the display control unit 165 causes the display 120 to display the annotation image 122-6 along with the image 121. The annotation image 122-6 is disposed in the upper left region of the display 120, similarly to the annotation image 122-1 in the example illustrated in FIG. 7.

In the illustrated example, the value analysis unit 163 specifies a time measurement value, based on the position relationship between the scale 311 of the first sub dial 31, and the short hand 411 and the long hand 412, and the position relationship between the first scale 301 of the main dial 30 and the chronograph second hand 403. Specifically, the value analysis unit 163 specifies the value of the scale 311 indicated by the short hand 411, as the time measurement value in units of ten minutes, specifies the value of the scale 311 indicated by the long hand 412, as the time measurement value in units of 1 minute, and specifies the value of the first scale 301 indicated by the chronograph second hand 403, as the time measurement value in units of 1 second. The image generation unit 164 generates an annotation image 122-7 indicating the measurement value of the specified time (1 minute and 38 seconds in total), and the display control unit 165 causes the display 120 to display the annotation image 122-7 along with the image 121. The annotation image 122-7 is disposed in the lower right region of the display 120, similarly to the annotation image 122-2 in the example illustrated in FIG. 7.

In the third screen display example as described above, the user can easily recognize the time measurement value indicated in the electronic timepiece 1 and that the chronograph mode is set in the electronic timepiece 1.

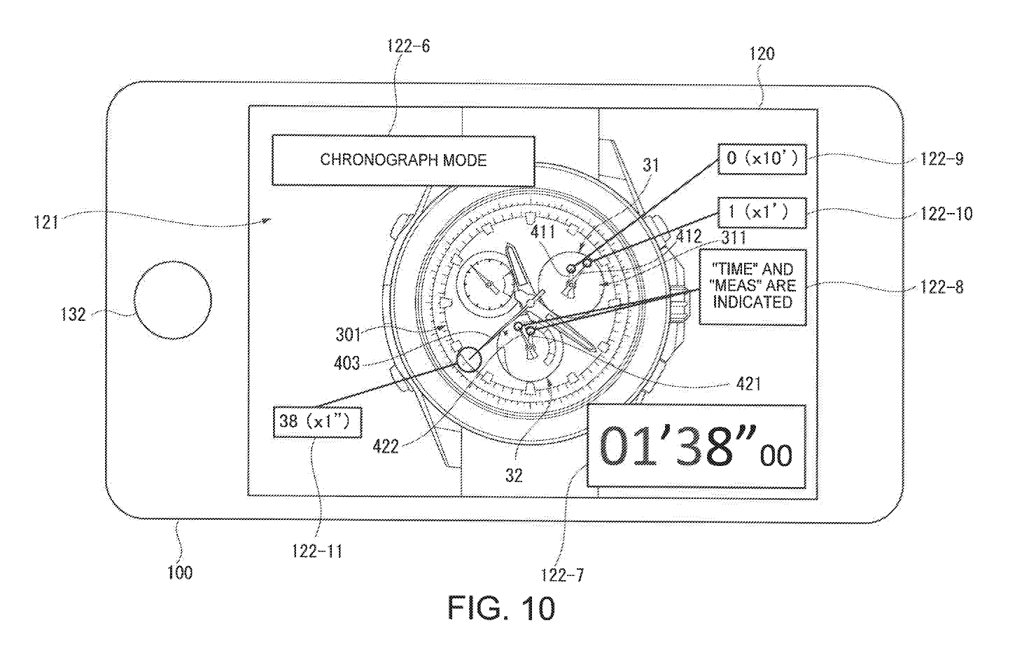

FIG. 10 illustrates a fourth screen display example according to the embodiment of the invention. The illustrated example is a screen display example different from that in FIG. 9 in a case where the chronograph mode is set in the electronic timepiece 1. In the example illustrated in FIG. 10, similarly to the example in FIG. 9, the indicating mode analysis unit 162 of the smartphone 100 specifies the chronograph mode set in the electronic timepiece 1, and the display control unit 165 causes the display 120 to display the annotation images 122-6 and 122-7 along with the image 121.

In the illustrated example, the image generation unit 164 generates another annotation image 122-8 relating to the chronograph mode specified by the indicating mode analysis unit 162. The annotation image 122-8 indicates that the short hand 421 on the second sub dial 32 indicates a portion having the character of “TIME” marked thereon in the chronograph mode, that the long hand 422 indicates a portion having the character of “MEAS” marked thereon. The annotation image 122-8 is displayed in association with each of the short hand 411 and the long hand 412 which are included as the imaged subject in the image 121.

Furthermore, in the illustrated example, the image generation unit 164 generates other annotation images 122-9 to 122-11 relating to the value (time measurement value) specified by the value analysis unit 163. The annotation image 122-9 indicates that the value of the scale 311 (0 at this time point) indicated by the short hand 411 on the first sub dial 31 is the time measurement value in units of 10 minutes, and is displayed in association with the short hand 411 included as the imaged subject in the image 121. Similarly, the annotation image 122-10 indicates that the value (1 at this time point) of the scale 311 indicated by the long hand 412 on the first sub dial 31 is the time measurement value in units of 1 minute, and is displayed in association with the long hand 412 included as the imaged subject in the image 121. The annotation image 122-11 indicates that the value (38 at this time point) of the first scale 301 indicated by the chronograph second hand 403 on the main dial 30 is the time measurement value in units of 1 second, and is displayed in association with the chronograph second hand 403 included as the imaged subject in the image 121.

In the above-described example, in the smartphone 100, the image recognition unit 161 recognizes the first position relationship between the dial and the first indicating hand (the position relationship between the second sub dial 32, and the short hand 421 and the long hand 422), and the second position relationship between the dial and the second indicating hand (the position relationship between the first sub dial 31, and the short hand 411 and the long hand 412, and the position relationship between the main dial 30 and the chronograph second hand 403). In this case, the indicating mode analysis unit 162 specifies the indicating mode (chronograph mode) corresponding to the first position relationship, and the value analysis unit 163 specifies the value (time measurement value) corresponding to the second position relationship. The display control unit 165 causes the display 120 to display the annotation images 122-9 and 122-10 relating to the specified indicating mode (chronograph mode) in association with the first indicating hand (the short hand 421 and the long hand 422 on the second sub dial 32).

According to another view point, in the above-described example, in the smartphone 100, the image recognition unit 161 recognizes the first position relationship between the dial and the first indicating hand (the position relationship between the first sub dial 31, and the short hand 411 and the long hand 412), and the second position relationship between the dial and the second indicating hand (the position relationship between the main dial 30 and the chronograph second hand 403)). In this case, the value analysis unit 163 recognizes the first value (the time measurement value in units of ten minutes and one minute) corresponding to the above-described first position relationship, and the second value (the time measurement value of time in units of seconds) corresponding to the second position relationship. The display control unit 165 causes the display 120 to display the annotation images 122-9 and 122-10 relating to the first value in association with the first indicating hand (the short hand 411 and the long hand 412 on the first sub dial 31), and causes the display 120 to display the annotation image 122-10 relating to the second value in association with the second indicating hand (the chronograph second hand 403).

In the fourth screen display example as described above, the annotation image 122-8 is displayed in association with the indicating hand (the short hand 421 and the long hand 422 on the second sub dial 32) indicating the chronograph mode in the electronic timepiece 1. Accordingly, the user easily recognizes that the indicating hands indicate the chronograph mode. In the above-described example, the annotation images 122-9 to 122-11 are displayed in association with each of the indicating hands (the short hand 411 and the long hand 412 on the first sub dial 31, and the chronograph second hand 403) in which the time measurement value is decomposed into a plurality of elements for display in the electronic timepiece 1. Accordingly, the user easily recognizes which element of the time measurement value is indicated by the indicating hands. In this manner, for example, even in a case where the user directly views the electronic timepiece 1 without using the smartphone 100, the user can easily recognize that the chronograph mode is set, and the time measurement value indicated in the chronograph mode.

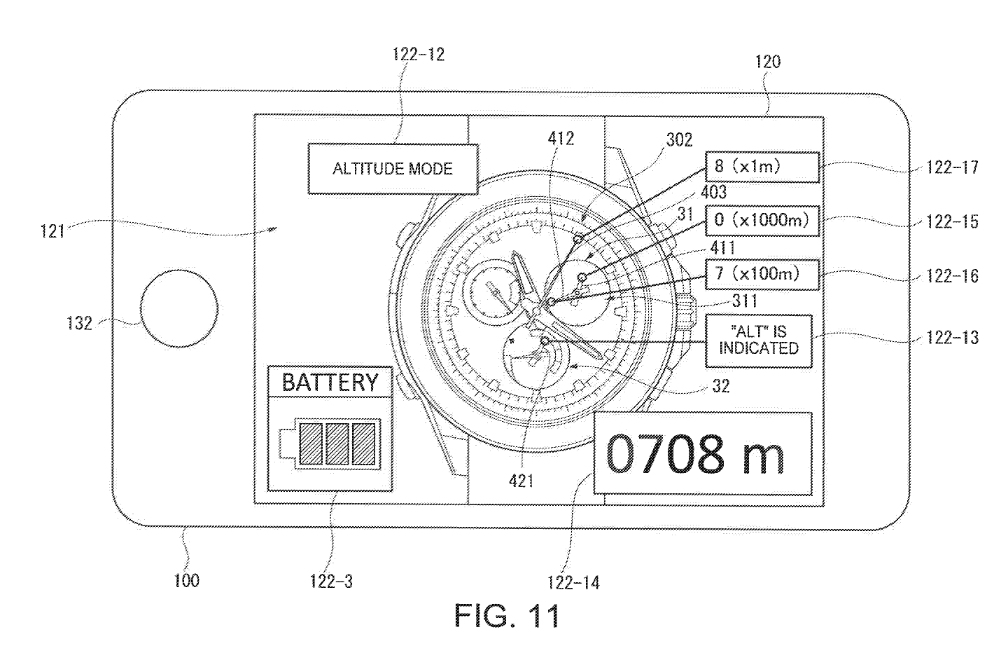

FIG. 11 illustrates a fifth screen display example according to the embodiment of the invention. In the illustrated example, the altitude mode is set in the electronic timepiece 1. In the electronic timepiece 1, the altitude mode is set, for example, in a case where the A-button 6 is pressed and released while the time mode is set. In the electronic timepiece 1, while the altitude mode is set, the short hand 421 on the second sub dial 32 indicates a portion having the character of “ALT” marked thereon. The indicating mode analysis unit 162 of the smartphone 100 specifies the altitude mode set in the electronic timepiece 1 in a case where the above-described condition is satisfied.

In the illustrated example, the image generation unit 164 generates an annotation image 122-12 indicating the indicating mode (altitude mode) specified by the indicating mode analysis unit 162, and the display control unit 165 causes the display 120 to display the annotation image 122-12 along with the image 121. The annotation image 122-12 is disposed in the upper left region of the display 120, similarly to the annotation image 122-1 in the example illustrated in FIG. 7.

In the illustrated example, the image generation unit 164 generates another annotation image 122-13 relating to the altitude mode specified by the indicating mode analysis unit 162. The annotation image 122-13 indicates that the short hand 421 on the second sub dial 32 indicates a portion having the character of “ALT” marked thereon in the altitude mode, and is displayed in association with the short hand 421 included as the imaged subject in the image 121.

On the other hand, in the illustrated example, the value analysis unit 163 specifies the altitude measurement value, based on the position relationship between the scale 311 of the first sub dial 31, and the short hand 411 and the long hand 412, and the position relationship between the second scale 302 of the main dial 30 and the chronograph second hand 403. The altitude measurement value is calculated, based on the measurement value of the barometric pressure sensor 563 in the electronic timepiece 1. Specifically, the value analysis unit 163 specifies the value of the scale 311 indicated by the short hand 411, as the altitude measurement value in units of 1,000 m, specifies the value of the scale 311 indicated by the long hand 412, as the altitude measurement value in units of 100 m, and specifies the value of the second scale 302 indicated by the chronograph second hand 403, as the altitude measurement value in units of 1 m. The image generation unit 164 generates an annotation image 122-14 showing the specified altitude measurement value (708 m in total in the illustrated example), and the display control unit 165 causes the display 120 to display the annotation image 122-14 along with the image 121. The annotation image 122-14 is disposed in the lower right region of the display 120, similarly to the annotation image 122-2 in the example illustrated in FIG. 7.

Furthermore, in the illustrated example, the image generation unit 164 generates other annotation images 122-15 to 122-17 relating to the value (altitude measurement value) specified by the value analysis unit 163. The annotation image 122-15 indicates that the value (smaller than 1 at this time point, that is, 0) of the scale 311 indicated by the short hand 411 on the first sub dial 31 is the altitude measurement value in units of 1,000 m. The display control unit 165 displays the annotation image 122-15 in association with the short hand 411 included as the imaged subject in the image 121. Similarly, the annotation image 122-16 indicates that the value (7 at this time point) of the scale 311 indicated by the long hand 412 on the first sub dial 31 is the altitude measurement value in units of 100 m, and is displayed in association with the long hand 412 included as the imaged subject in the image 121. The annotation image 122-17 indicates that the value (8 at this time point) of the second scale 302 indicated by the chronograph secondhand 403 on the main dial 30 is the altitude measurement value in units of 1 m, and is displayed in association with the chronograph secondhand 403 included as the imaged subject in the image 121.

In the illustrated example, similarly to the example illustrated in FIG. 7, through the processes of the value analysis unit 163, the image generation unit 164, and the display control unit 165, the annotation image 122-3 indicating the battery remaining capacity is displayed along with the image 121. In the embodiment, regardless of the display mode specified by the indicating mode analysis unit 162, the annotation image 122-3 is displayed in a case where the other annotation image 122 is not displayed in the lower left region of the display 120 (in the following example, the illustrated annotation image 122-3 will not be described in particular).

In the fifth screen display example as described above, similarly to the fourth screen display example, the annotation image 122-13 is displayed in association with the indicating hand (the short hand 421 on the second sub dial 32) indicating the altitude mode in the electronic timepiece 1. Accordingly, the user easily recognizes that the indicating hand indicates the altitude mode. In the above-described example, similarly to the fourth screen display example, the annotation images 122-15 to 122-17 are displayed in association with each of the indicating hands (the short hand 411 and the long hand 412 on the first sub dial 31, and the chronograph second hand 403) in which the altitude measurement value is decomposed into a plurality of elements for display in the electronic timepiece 1. Accordingly, the user easily recognizes which element of the altitude measurement value is indicated by the indicating hands. In this manner, for example, even in a case where the user directly views the electronic timepiece 1 without using the smartphone 100, the user can easily recognize that the altitude mode is set, and the altitude measurement value indicated in the altitude mode.

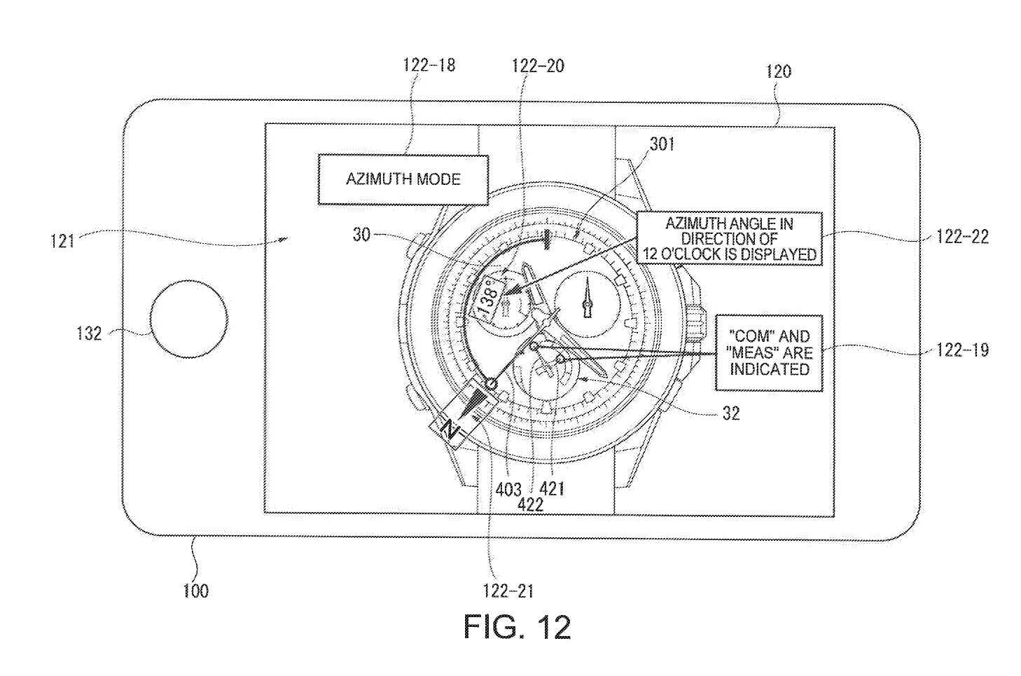

FIG. 12 illustrates a sixth screen display example according to the embodiment of the invention. In the illustrated example, the azimuth mode is set in the electronic timepiece 1. In the electronic timepiece 1, the azimuth mode is set, for example, in a case where the A-button 6 is pressed and released while the altitude mode is set. In the electronic timepiece 1, while the azimuth mode is set, the short hand 421 on the second sub dial 32 indicates a portion having the character of “COM” marked thereon, and the long hand 422 indicates a portion having the character of “MEAS” marked thereon. The indicating mode analysis unit 162 of the smartphone 100 specifies the azimuth mode set in the electronic timepiece 1 in a case where the above-described condition is satisfied.

In the illustrated example, the image generation unit 164 generates an annotation image 122-18 indicating the indicating mode (azimuth mode) specified by the indicating mode analysis unit 162, and the display control unit 165 causes the display 120 to display the annotation image 122-18 along with the image 121. The annotation image 122-18 is disposed in the upper left region of the display 120, similarly to the annotation image 122-1 in the example illustrated in FIG. 7.

In the illustrated example, the image generation unit 164 generates another annotation image 122-19 relating to the mode (azimuth mode) specified by the indicating mode analysis unit 162. The annotation image 122-19 indicates that the shorthand 421 on the second sub dial 32 indicates a portion having the character of “COM” marked thereon in the azimuth mode, and that the long hand 422 indicates a portion having the character of “MEAS” marked thereon. The annotation image 122-19 is displayed in association with the short hand 421 and the long hand 422 which are included as the imaged subject in the image 121.

On the other hand, in the illustrated example, the value analysis unit 163 specifies the azimuth angle measurement value, based on the position relationship between the first scale 301 of the main dial 30 and the chronograph second hand 403. The azimuth angle measurement value is calculated, based on the measurement value of the geomagnetic sensor 562 in the electronic timepiece 1. Specifically, the value analysis unit 163 specifies the value of the first scale 301 indicated by the chronograph second hand 403, as the azimuth angle measurement value. Here, the azimuth angle means the angle in the direction of 12 o' clock when viewed from the plane center of the main dial 30 in a case where the dial 3 is held in substantially the horizontal direction and the direction toward the north is set to 0°. In the illustrated example, the azimuth angle is 90° if the direction of 12 o' clock is the east, is 180° if the direction of 12 o'clock is the south, and is 270° if the direction of 12 o' clock is the west. One scale of the first scale 301 which divides the outer periphery of the main dial 30 into 60 corresponds to the azimuth angle of 6°.

In the above-described example, the image generation unit 164 generates an annotation image 122-20 indicating the measurement value of the specified azimuth angle (138° in the illustrated example). The annotation image 122-19 includes an arc of an angle (that is, as large as 138°) corresponding to the azimuth angle measurement value and a number indicating the azimuth angle measurement value. The display control unit 165 causes the display 120 to display the annotation image 122-20 along with the image 121. Specifically, the display control unit 165 displays the annotation image 122-20 by superimposing the annotation image 122-20 on a section from a zero position (12 o'clock) of the first scale 301 of the main dial 30 included as the imaged subject in the image 121 up to the tip of the chronograph second hand 403 along the first scale 301.

Furthermore, in the illustrated example, the image generation unit 164 generates other annotation images 122-21 and 122-22 relating to the value (azimuth angle measurement value) specified by the value analysis unit 163. The annotation image 122-21 indicates that the direction indicated by the chronograph second hand 403 is the north direction specified based on the azimuth angle measurement value. The display control unit 165 displays the annotation image 122-21 in association with the chronograph second hand 403 included as the imaged subject in the image 121. Specifically, the display control unit 165 displays the annotation image 122-21 on an extension line of the chronograph second hand 403. The annotation image 122-22 indicates that the azimuth angle indicated by the annotation image 122-20 is the azimuth angle in the direction of 12 o'clock, and is displayed in association with a numerical portion indicating the azimuth angle measurement value of the annotation image 122-20.

In the sixth screen display example as described above, similarly to the fourth and fifth screen display examples, the annotation image 122-19 is displayed in association with the indicating hand (the short hand 411 on the second sub dial 32) indicating the azimuth mode in the electronic timepiece 1. Accordingly, the user easily recognizes that the indicating hand indicates the azimuth mode. In the above-described example, the annotation images 122-20 to 122-22 are displayed in association with the indicating hand (the chronograph secondhand 403) indicating the azimuth angle measurement value in the electronic timepiece 1. Accordingly, the user easily recognizes how the indicating hand indicates the azimuth angle measurement value. In this manner, for example, even in a case where the user directly views the electronic timepiece 1 without using the smartphone 100, the user can easily recognize that the azimuth mode is set, and the azimuth angle measurement value indicated in the azimuth mode.

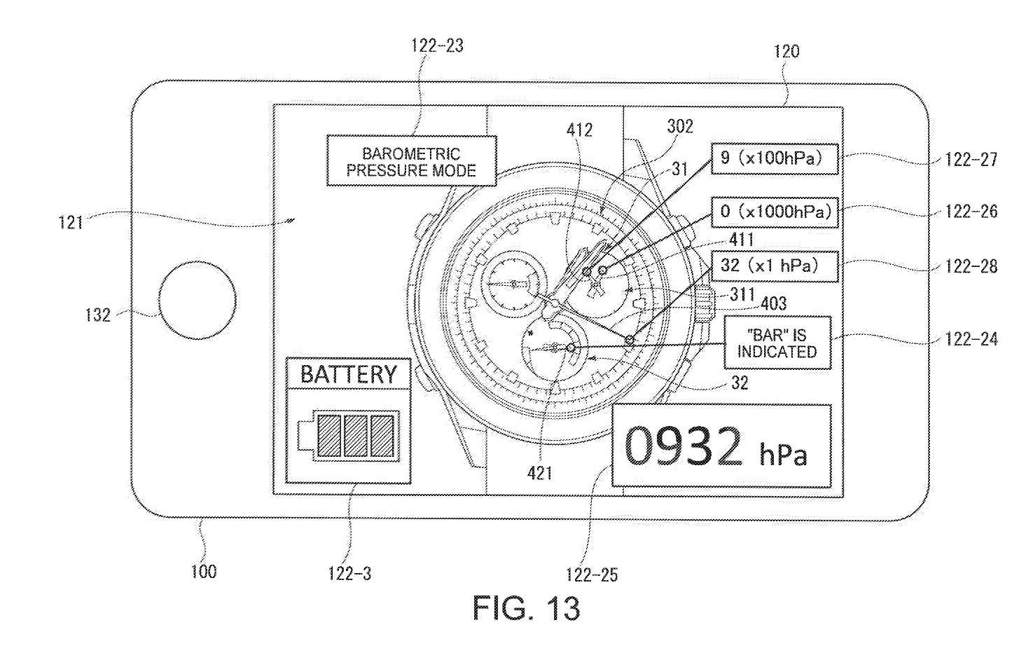

FIG. 13 illustrates a seventh screen display example according to the embodiment of the invention. In the illustrated example, the barometric pressure mode is set in the electronic timepiece 1. In the electronic timepiece 1, the barometric pressure mode is set, for example, in a case where the A-button 6 is pressed and released while the azimuth mode is set. In the electronic timepiece 1, while the barometric pressure mode is set, the short hand 421 on the second sub dial 32 indicates a portion having the character of “BAR” marked thereon. The indicating mode analysis unit 162 of the smartphone 100 specifies the barometric pressure mode set in the electronic timepiece 1 in a case where the above-described condition is satisfied.

In the illustrated example, the image generation unit 164 generates an annotation image 122-23 indicating the indicating mode (barometric pressure mode) specified by the indicating mode analysis unit 162, and the display control unit 165 causes the display 120 to display the annotation image 122-23 along with the image 121. The annotation image 122-23 is disposed in the upper left region of the display 120, similarly to the annotation image 122-1 in the example illustrated in FIG. 7.

In the illustrated example, the image generation unit 164 generates another annotation image 122-24 relating to the mode (barometric pressure mode) specified by the indicating mode analysis unit 162. The annotation image 122-24 indicates that the short hand 421 on the second sub dial 32 indicates a portion having the character of “BAR” marked thereon in the altitude mode, and is displayed in association with the short hand 421 included as the imaged subject in the image 121.

On the other hand, in the illustrated example, the value analysis unit 163 specifies the barometric pressure measurement value, based on the position relationship between the scale 311 of the first sub dial 31, the short hand 411 and the long hand 412, and the position relationship between the second scale 302 of the main dial 30 and the chronograph second hand 403. The barometric pressure measurement value is measured by the barometric pressure sensor 563 in the electronic timepiece 1. Specifically, the value analysis unit 163 specifies the value of the scale 311 indicated by the short hand 411, as the barometric pressure measurement value in units of 1,000 hPa, specifies the value of the scale 311 indicated by the long hand 412, as the barometric pressure measurement value in units of 100 hPa, and specifies the value of the second scale 302 indicated by the chronograph second hand 403, as the barometric pressure measurement value in units of 1 hPa. The image generation unit 164 generates an annotation image 122-25 indicating the measurement value of the specified barometric pressure (932 hPa in the illustrated example), and the display control unit 165 causes the display 120 to display the annotation image 122-25 along with the image 121. The annotation image 122-25 is disposed in the lower right region of the display 120, similarly to the annotation image 122-2 in the example illustrated in FIG. 7.

Furthermore, in the illustrated example, the image generation unit 164 generates other annotation images 122-26 to 122-28 relating to the value (barometric pressure measurement value) specified by the value analysis unit 163. The annotation image 122-26 indicates that the value (smaller than 1 at this time point, that is, 0) of the scale 311 indicated by the short hand 411 on the first sub dial 31 is the barometric pressure measurement value in units of 1,000 hPa. The display control unit 165 displays the annotation image 122-26 in association with the short hand 411 included as the imaged subject in the image 121. Similarly, the annotation image 122-27 indicates that the value of the scale 311 (9 at this time point) indicated by the long hand 412 on the first sub dial 31 is the barometric pressure measurement value in units of 100 hPa, and is displayed in association with the long hand 412 included as the imaged subject in the image 121. The annotation image 122-28 indicates that the value (32 at this time point) of the second scale 302 indicated by the chronograph second hand 403 on the main dial 30 is the barometric pressure measurement value in units of 1 hPa, and is displayed in association with the chronograph second hand 403 included as the imaged subject in the image 121.

In the seventh screen display example as described above, similarly to the fourth to sixth screen display examples, the annotation image 122-24 is displayed in association with the indicating hand (the short hand 421 on the second sub dial 32) indicating the barometric pressure mode in the electronic timepiece 1. Accordingly, the user easily recognizes that the indicating hand indicates the barometric pressure mode. In the above-described example, similarly to the fourth and fifth screen display examples, the annotation images 122-26 to 122-28 are displayed in association with each of the indicating hands (the short hand 411 and the long hand 412 on the first sub dial 31, and the chronograph second hand 403) in which the barometric pressure measurement value is decomposed into a plurality of elements for display in the electronic timepiece 1. Accordingly, the user easily recognizes which element of the barometric pressure measurement value is indicated by the indicating hands. In this manner, for example, even in a case where the user directly views the electronic timepiece 1 without using the smartphone 100, the user can easily recognize that the barometric pressure mode is set, and the barometric pressure measurement value indicated in the barometric pressure mode.

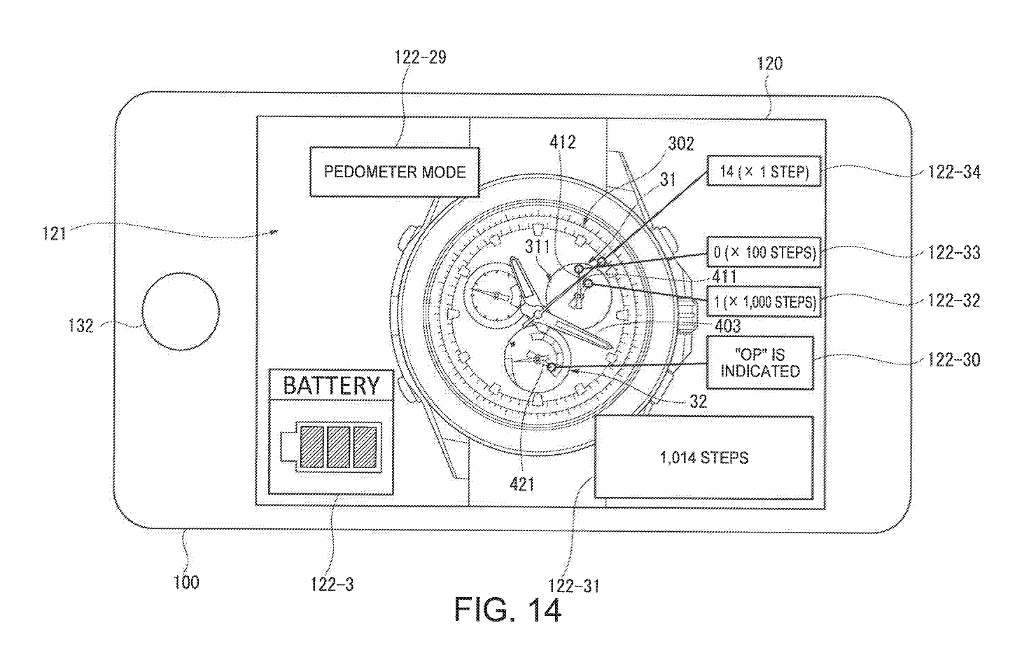

FIG. 14 illustrates an eighth screen display example according to the embodiment of the invention. In the illustrated example, the pedometer mode is set in the electronic timepiece 1. In the electronic timepiece 1, the pedometer mode is set, for example, in a case where the A-button 6 is pressed and released while the barometric pressure mode is set. In the electronic timepiece 1, while the pedometer mode is set, the short hand 421 on the second sub dial 32 indicates a portion having the character of “OP” marked thereon. The indicating mode analysis unit 162 of the smartphone 100 specifies the pedometer mode set in the electronic timepiece 1 in a case where the above-described condition is satisfied.

In the illustrated example, the image generation unit 164 generates an annotation image 122-29 indicating the indicating mode (pedometer mode) specified by the indicating mode analysis unit 162, and the display control unit 165 causes the display 120 to display the annotation image 122-29 along with the image 121. The annotation image 122-29 is disposed in the upper left region of the display 120, similarly to the annotation image 122-1 in the example illustrated in FIG. 7.

In the illustrated example, the image generation unit 164 generates another annotation image 122-30 relating to the mode (pedometer mode) specified by the indicating mode analysis unit 162. The annotation image 122-30 indicates that the shorthand 421 on the second sub dial 32 indicates a portion having the character of “OP” marked thereon in the pedometer mode, and is displayed in association with the short hand 421 included as the imaged subject in the image 121.

On the other hand, in the illustrated example, the value analysis unit 163 specifies the number of walking steps, based on the position relationship between the scale 311 of the first sub dial 31, and the short hand 411 and the long hand 412, and the position relationship between the second scale 302 of the main dial 30 and the chronograph second hand 403. The number of walking steps is counted, based on the measurement value of the acceleration sensor 561 in the electronic timepiece 1. The number of walking steps is continuously counted while the pedometer mode is not set in the electronic timepiece 1. Specifically, the value analysis unit 163 specifies the value of the scale 311 indicated by the short hand 411, as the number of walking steps in units of 1000, specifies the value of the scale 311 indicated by the longhand 412, as the number of walking steps in units of 100, and specifies the value of the second scale 302 indicated by the chronograph second hand 403, as the number of walking steps in units of 1. The image generation unit 164 generates an annotation image 122-31 indicating the measurement value (1,014 steps in total in the illustrated example) of the specified number of walking steps, and the display control unit 165 causes the display 120 to display the annotation image 122-31 along with the image 121. The annotation image 122-31 is disposed in the lower right region of the display 120, similarly to the annotation image 122-2 in the example illustrated in FIG. 7.

As described above, in another example, the electronic timepiece 1 may receive the measurement value of a sensor included in the sensor device separate from the electronic timepiece 1, and the value based on the received measurement value may be indicated using the dial 3 and the indicating hand 4. Specifically, in the sensor device separate from the electronic timepiece 1, the number of walking steps based on the measurement value of the acceleration sensor may be continuously counted. In this case, the electronic timepiece 1 may receive the measurement value of the number of walking steps from the sensor device when the pedometer mode is set, and as described above, the received measurement value may be indicated using the short hand 411 and the long hand 412 on the first sub dial 31 and the chronograph second hand 403 on the main dial 30.

Furthermore, in the illustrated example, the image generation unit 164 generates other annotation images 122-32 to 122-34 relating to the value (the number of walking steps) specified by the value analysis unit 163. The annotation image 122-32 indicates that the value (1 at this time point) of the scale 311 indicated by the short hand 411 on the first sub dial 31 is the number of walking steps in units of 1,000. The display control unit 165 displays the annotation image 122-32 in association with the short hand 411 included as the imaged subject in the image 121. Similarly, the annotation image 122-33 indicates that the value (0 at this time point) of the scale 311 indicated by the long hand 412 on the first sub dial 31 is the number of walking steps in units of 100, and is displayed in association with the long hand 412 included as the imaged subject in the image 121. The annotation image 122-34 indicates that the value (14at this time point) of the second scale 302 indicated by the chronograph second hand 403 on the main dial 30 is the number of walking steps in units of 1, and is displayed in association with the chronograph second hand 403 included as the imaged subject in the image 121.

In the eighth screen display example as described above, similarly to the fourth to seventh screen display examples, the annotation image 122-30 is displayed in association with the indicating hand (the short hand 421 on the second sub dial 32) indicating the pedometer mode in the electronic timepiece 1. Accordingly, the user easily recognizes that the indicating hand indicates the pedometer mode. In the above-described example, similarly to the fourth, fifth and seventh screen display examples, the annotation images 122-32 to 122-34 are displayed in association with each of the indicating hands (the short hand 411 and the long hand 412 on the first sub dial 31, and the chronograph second hand 403) in which the measurement value of the number of walking steps is decomposed into a plurality of elements for display in the electronic timepiece 1. Accordingly, the user easily recognizes which element of the number of walking steps is indicated by the indicating hands. In this manner, for example, even in a case where the user directly views the electronic timepiece 1 without using the smartphone 100, the user can easily recognize that the pedometer mode is set, and the number of walking steps indicated in the pedometer mode.

Hitherto, the embodiment according to the invention has been described. The embodiment according to the invention is not limited to the above-described examples, and various modified embodiments can be made within the obvious scope to those having ordinary knowledge in the technical field to which the invention belongs. It is understood that the modified embodiments naturally belong to the technical scope of the invention.

For example, in the above-described embodiment, the smartphone 100 has been described as an example of the information display device. However, other devices such as a personal computer, a tablet computer, and a wearable device can be operated as the information display device, similarly to the smartphone 100. In a case where a network server which communicates with a device such as the smartphone 100 including the camera 110 and the display 120 via a network provides at least a partial function of the above-described control unit 160 (the image recognition unit 161, the indicating mode analysis unit 162, the value analysis unit 163, the image generation unit 164, and the display control unit 165), the server functions as the information display device according to the embodiment of the invention.

For example, in the above-described embodiment, an example has been described in which the image dictionary for the image recognition process performed by the image recognition unit 161 of the smartphone 100 is stored in the storage unit 140. However, the image dictionary may be partially or entirely stored in network storage, and the smartphone 100 may download the required image dictionary from the storage by using the communication unit 150, if necessary. Similarly, the specification information of the electronic timepiece 1 for the analysis process performed by the indicating mode analysis unit 162 and the value analysis unit 163 may be partially or entirely stored in the network storage, and the smartphone 100 may download the required specification information from the storage by using the communication unit 150, if necessary.

For example, in the above-described embodiment, an example has been described in which the electronic timepiece 1 includes the main dial 30 and the first sub dial 31 to the third sub dial 33 in the dial 3. However, the electronic timepiece 1 may not include the sub dial in the dial 3, or may include two, four or more sub dials in the dial 3. As a method of indicating the value such as the sensor measurement value by using the position relationship between the dial 3 and the indicating hand 4, various methods can be employed regardless of the examples in the above-described embodiment.

For example, in the above-described embodiment, the position relationship between the first indicating hand and the dial of the electronic timepiece 1 indicates the indicating mode, and the position relationship between the second indicating hand different from the first indicating hand and the dial indicates the value. However, as other embodiments, the position relationship between a single indicating hand and the dial may indicate both the indicating mode and the value. For example, in a case where a region located on the sub dial indicates only a specific indicating mode, in the smartphone 100, the indicating mode analysis unit 162 may specify the indicating mode, based on the position relationship in which the sub indicating hand indicates the region, and the value analysis unit 163 may specify the value, based on the position relationship between the scale and the sub indicating hand inside the region.

For example, the embodiment according to the invention may include the information display device, the information display method, the system including the electronic timepiece and the information display device which are described above, the program for providing a function as an information processing device, and a non-transitory tangible medium having the program recorded thereon.

What is claimed is:

1. An information display method comprising:
recognizing a position relationship between a dial and an indicating hand from an image in which an electronic timepiece having a dial and an indicating hand for indicating the dial is included as an imaged subject;
specifying a value corresponding to the position relationship, based on specification information of the electronic timepiece; and
displaying an annotation image relating to the specified value along with the image.

2. The information display method according to claim 1,
wherein the dial includes a main dial, and a sub dial disposed in a partial region of the main dial,
wherein the indicating hand includes a sub indicating hand for indicating the sub dial, and
wherein in the recognizing the position relationship, the position relationship between the sub dial and the sub indicating hand is recognized.

3. The information display method according to claim 1,
wherein in the specifying the value, the value is specified, based on a sensor measurement value indicated by the electronic timepiece.

4. The information display method according to claim 2,
wherein in the specifying the value, the value is specified, based on a sensor measurement value indicated by the electronic timepiece.

5. The information display method according to claim 1,
wherein in the displaying the annotation image, the annotation image is displayed in association with the indicating hand for indicating the specified value.

6. The information display method according to claim 3,
wherein in the displaying the annotation image, the annotation image is displayed in association with the indicating hand for indicating the specified value.

7. The information display method according to claim 5,
wherein the indicating hand includes a first indicating hand and a second indicating hand,
wherein in the recognizing the position relationship, a first position relationship between the dial and the first indicating hand and a second position relationship between the dial and the second indicating hand are recognized,
wherein in the specifying the value, a first value corresponding to the first position relationship and a second value corresponding to the second position relationship are specified, and
wherein in the displaying the annotation image, the annotation image relating to the first value is displayed in association with the first indicating hand, and the annotation image relating to the second value is displayed in association with the second indicating hand.

8. The information display method according to claim 7,
wherein in the displaying the annotation image, the annotation image relating to a value whose elements are the first value and the second value is further displayed.

9. The information display method according to claim 1,
wherein the specification information includes first specification information that associates a plurality of indicating modes settable in the electronic timepiece with the position relationship, and second specification information that associates a value indicated by each of the plurality of indicating modes with the position relationship, and
wherein in the specifying the value, the indicating mode corresponding to the position relationship is specified, based on the first specification information, and the value corresponding to the position relationship is specified, based on the second specification information and the specified indicating mode.

10. The information display method according to claim 6,
wherein the specification information includes first specification information that associates a plurality of indicating modes settable in the electronic timepiece with the position relationship, and second specification information that associates a value indicated by each of the plurality of indicating modes with the position relationship, and
wherein in the specifying the value, the indicating mode corresponding to the position relationship is specified, based on the first specification information, and the value corresponding to the position relationship is specified, based on the second specification information and the specified indicating mode.

11. The information display method according to claim 9,
wherein the annotation image includes the annotation image relating to the specified indicating mode.

12. The information display method according to claim 11,
wherein the indicating hand includes a first indicating hand and a second indicating hand,
wherein in the recognizing the position relationship, a first position relationship between the dial and the first indicating hand and a second position relationship between the dial and the second indicating hand are recognized,
wherein in the specifying the value, the indicating mode corresponding to the first position relationship is specified, based on the first specification information, and the value corresponding to the second position relationship is specified, based on the second specification information and the specified indicating mode, and
wherein in the displaying the annotation image, the annotation image relating to the specified indicating mode is displayed in association with the first indicating hand.

13. The information display method according to claim 1,
wherein in the recognizing the position relationship, models of the electronic timepiece are recognized from the image, and
wherein in the specifying the value, the value corresponding to the position relationship is recognized, based on the specification information prepared for each of the models.

14. The information display method according to claim 10,
wherein in the recognizing the position relationship, models of the electronic timepiece are recognized from the image, and
wherein in the specifying the value, the value corresponding to the position relationship is recognized, based on the specification information prepared for each of the models.

15. The information display method according to claim 12,
wherein in the recognizing the position relationship, models of the electronic timepiece are recognized from the image, and
wherein in the specifying the value, the value corresponding to the position relationship is recognized, based on the specification information prepared for each of the models.

16. A system comprising:
an electronic timepiece that includes a dial, an indicating hand for indicating the dial, and an indicating hand drive control unit which controls driving of the indicating hand so as to indicate a value by using a position relationship with the dial; and
an information display device that includes an imaging unit which acquires an image in which the electronic timepiece is included as an imaged subject, an image recognition unit which recognizes the position relationship between the dial and the indicating hand from the image, an analysis unit which specifies the value, based on specification information of the electronic timepiece and the position relationship, and a display control unit which displays an annotation image relating to the specified value along with the image.

17. An information display device comprising:
an image recognition unit that recognizes a position relationship between a dial and an indicating hand from an image in which an electronic timepiece having the dial and the indicating hand for indicating the dial are included as an imaged subject;
an analysis unit that specifies a value corresponding to the position relationship, based on specification information of the electronic timepiece; and
a display control unit that displays an annotation image relating to the specified value along with the image.
